(19) United States
(12) Patent Application Publication
(10) Pub. No.: US 2009/0034122 A1
(43) Pub. Date: Feb. 5, 2009

(54) STRUCTURE AND PROCESS FOR PRODUCTION THEREOF

(75) Inventors: Shigeru Ichihara, Tokyo (JP); Toru Den, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/179,841

(22) Filed: Jul. 25, 2008

(30) Foreign Application Priority Data
Aug. 2, 2007 (JP) 2007-202366

(51) Int. Cl. G11B 5/74; B05D 5/12; G11B 5/70

(52) U.S. Cl. 360/131; 427/127; 428/848

(57) ABSTRACT

A structure has projecting structural members perpendicular to a substrate, the projecting structural members having respectively a curved top-end face covered continuously with a magnetic material. A process for producing a structure comprises the steps of placing an underlying metal layer and an anode-oxidization layer successively on a substrate, anodizing the anode-oxidization layer to form a porous film having pores perpendicular to the substrate, growing an oxide of a metal of the underlying metal layer from the bottoms of the pores of the porous film to outside of the porous film to form projecting structural members through the pores, each constituted of a columnar structural portion and a curve-faced top-end portion, removing a part or the entire of the porous film, and placing a magnetic material on the top-end portions of the projecting structural members.

### BACKGROUND OF THE INVENTION

1. Field of the Invention

The present invention relates to a structure, and a process for production thereof.

2. Description of the Related Art

With rapid increase of the amount of information, higher recording density is demanded of magnetic recording device typified by hard disk drives (HDD). For the higher recording density, the magnetic domains in the recording magnetic layer should be made finer by making the magnetic particles finer. However, the finer magnetic particles will decrease the magnetic anisotropy energy to cause thermal fluctuation to render the recording magnetization instable. To prevent the adverse effect of the thermal fluctuation, patterned mediums are disclosed. The patterned medium has recording magnetic domains constituted of a magnetic body segmented finely in a uniform size and a uniform pitch, being capable of retaining the magnetic anisotropy energy more readily than conventional continuous medium, and having excellent resistance to thermal fluctuation.

Although the patterned medium is promising as a next-generation recording medium, the entire magnetic recording system should also be optimized for the higher density of the recording medium. For the higher density of the recording, not only the pattern size but also the area of the magnetic pole confronting the magnetic recording medium should be made smaller. However, the smaller magnetic pole area will decrease directly the intensity of the recording magnetic field, and can lower the recording performance of the recording head. Further, of the patterned medium, nonuniformity of the pattern shape and pattern pitch can cause positional deviation of the magnetic pattern from the magnetic pole in the writing, which decreases the effective recording magnetic field intensity and lower the recording efficiency. Anyway, in the magnetic recording system employing the patterned medium, a recording system should correspond to the decreased magnetic field intensity.

To solve the above problems, a method is reported which inclines the easy direction of magnetization relative to the direction of the magnetic field for head recording to raise the recording sensitivity (IEEE. Transactions on Magnetics: vol. 39, No. 2, pp. 704-709 (2003)). Inclination of the easy direction of magnetization by 45° from the direction of the magnetic field of head recording enables decrease of the magnetic field for reversal of magnetization by half to improve the recording sensitivity with retention of the resistance to thermal fluctuation of the recording medium.

Reports are presented which control the easy direction of magnetization for increasing the recording sensitivity. An example is an invention of a discrete track medium (Japanese Patent Application Laid-Open No. 2006-48864 (Patent Document 1)). This invention relates to a magnetic recording medium in which the magnetic layer pattern of the recording layer segmented by grooves has a taper inclined by an angle relative to the perpendicular magnetic anisotropy axis, whereby the effective recording magnetic field of the head is inclined relative to the magnetic anisotropy of the crystal of the magnetic layer.

In another report, a magnetic film is laminated on a face on which nonmagnetic nano-fine particles are arranged uniformly (Nature Material, vol. 4, pp. 203-206 (2005), (Non-Patent Document 1)). According to this report, a magnetic film is formed to have magnetic anisotropy perpendicular to the direction of the tangent line for the upper face of the bared spherical nano-fine particles to provide a system having magnetization direction partly inclined to the head recording magnetic field perpendicular to the substrate.

However, the above Patent Document 1 relates to a discrete track medium. This medium, which is produced by direct working of a magnetic body, cannot readily be applied to the patterned medium for high recording density as high as 1 Tbpsi (terabit per square inch). The technique disclosed by the above Non-Patent Document 1 cannot readily achieve the magnetic segmentation for the patterned medium. Thus no patterned medium has not been produced yet which satisfies the necessary conditions.

### SUMMARY OF THE INVENTION

The present invention intends to solve the above problems. The present invention intends to provide a structure having a thermal fluctuation resistance and a high recording sensitivity, prepared by placing a magnetic material having magnetic anisotropy inclined relative to the magnetic direction of head recording on a projection-arranged structure member. The present invention intends also to provide a process for producing the structure.

The present invention intends also to provide a magnetic recording medium comprising the aforementioned structure.

The present invention is directed to a structure having projecting structural members perpendicular to a substrate, the projecting structural members having respectively a curved top-end face covered continuously with a magnetic material.

The projecting structural members can be respectively constituted of a top-end portion and a columnar structural portion, and the top end portion can have a horizontal cross-sectional maximum diameter larger than a diameter of the columnar structural portion.

The columnar structural portion can have a horizontal cross-sectional diameter larger at the surface side than at the substrate side.

The magnetic material can have magnetic anisotropy oriented to be normal to the curved top-end face.

The projecting structural member can be constituted of at least one oxide of the elements selected from Nb, Ta, Ti, Hf, Zr, Mo, and W.

The projecting structural members can be uniform in shape, and can be arrayed at uniform intervals.

The present invention is directed to a magnetic recording medium, comprising the structure.

The present invention is directed to a process for producing a structure, comprising the steps of: placing an underlying metal layer and an anode-oxidization layer successively on a substrate; anodizing the anode-oxidization layer to form a porous film having pores perpendicular to the substrate; growing an oxide of a metal element of the underlying metal layer from the bottoms of the pores of the porous film to form columnar structural members in the pores; polishing partly the porous film and the columnar structural members; forming a projecting structural members, each being constituted of the columnar structural member and a curve-faced top end portion; removing a part or the entire of the porous film; and placing a magnetic material on the top end portions of the projecting structural members.

The present invention is directed to a process for producing a structure, comprising the steps of: placing an underlying metal layer and an anode-oxidization layer successively on a substrate; anodizing the anode-oxidization layer to form a porous film having pores perpendicular to the substrate; growing an oxide of a metal of the underlying metal layer from the bottoms of the pores of the porous film to outside of the porous film to form projecting structural members through the pores, each constituted of a columnar structural portion and a curve-faced top-end portion; removing a part or the entire of the porous film; and placing a magnetic material on the top-end portions of the projecting structural members.

The underlying metal layer can be constituted of at least one oxide of the elements selected from Nb, Ta, Ti, Hf, Zr, Mo, and W.

The projecting structural members can be formed by second anodization.

The second anodization can be conducted in an electrolytic solution selected from of an aqueous ammonium borate solution, an aqueous ammonium tartarate solution, and an aqueous ammonium citrate solution.

The step of removing a part or the entire of the porous film can be conducted by wet-etching.

The projecting structural members can be heat-treated in an oxidative atmosphere.

The step of placing the magnetic material can be conducted by deposition of a fly-incoming particles for film formation having directivity toward the substrate.

The process includes placing an intermediate layer can be placed between the projecting structural member and the magnetic material.

The present invention provides a structure having high thermal fluctuation resistance and high recording sensitivity, and a process for producing the structure. The present invention provides also a magnetic recording medium comprising the aforementioned structure.

Further features of the present invention will become apparent from the following description of exemplary embodiments with reference to the attached drawings.

### BRIEF DESCRIPTION OF THE DRAWINGS

FIG. 1 is a sectional view illustrating a process for forming a porous film by anodization.

FIG. 2 is a sectional view illustrating a porous film formed by anodization in an embodiment.

FIG. 3 is a sectional view illustrating a porous film formed by anodization in another embodiment.

FIG. 4 is a sectional view illustrating a porous film formed by anodization in still another embodiment.

FIG. 5 is a sectional view illustrating a process of growth of an oxide of an underlying metal to fill pores of the porous film.

FIG. 6 is a sectional view illustrating a process of growth of an oxide of an underlying metal to fill pores of the porous film.

FIG. 7 is a sectional view illustrating a structure comprising a projecting structural part.

FIG. 8 is a sectional view illustrating a structure comprising a projecting structural part.

FIG. 9 is a sectional view illustrating a structure comprising a projecting structural part.

FIG. 10 is a sectional view illustrating a structure comprising a projecting structural part.

FIG. 11 is a sectional view illustrating a structure of an embodiment of the present invention.

FIG. 12 is a sectional view illustrating a structure of another embodiment of the present invention.

FIG. 13 is a sectional view illustrating a structure of still another embodiment of the present invention.

FIG. 14 is a sectional view illustrating still another structure of an embodiment of the present invention.

FIG. 15 is a sectional view of a projecting structural part.

FIG. 16 is a sectional view of a projecting structural part.

FIG. 17 is a sectional view of an embodiment of a magnetic recording medium of the present invention.

### DESCRIPTION OF THE EMBODIMENTS

The present invention is described below in detail.

Embodiments of the present invention are described below.

In formation of a structure of the present invention, a porous film is preferably formed by an anodization process. This process is described below in detail.

On a substrate, an underlying metal layer, and an anode-oxidizable layer are formed successively by a thin film formation method like sputtering to obtain a workpiece. The above underlying metal layer is formed from a material containing at least one element selected from the group consisting of Nb, Ta, Ti, Hf, Zr, Mo, and W. The above anode-oxidizable layer is formed from Al or an alloy mainly composed of Al.

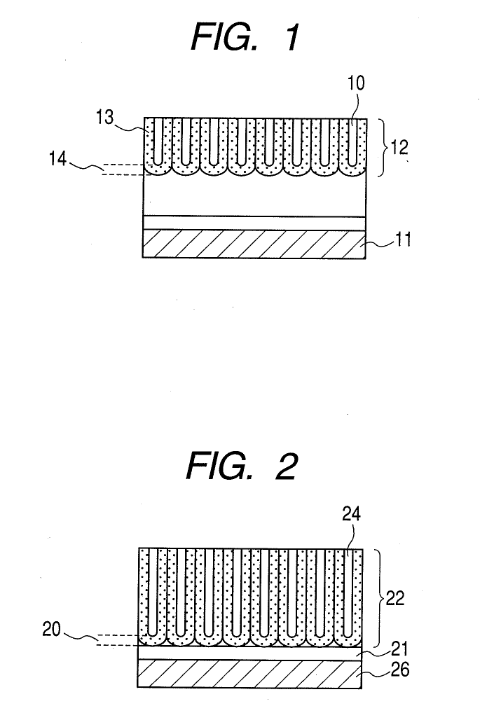

The workpiece is subjected to anodization in an aqueous acidic solution like phosphoric acid, oxalic acid, or sulfuric acid. Thereby, as illustrated in FIG. 1, many pores 10 grow from the surface of the workpiece perpendicularly toward substrate 11 to form porous film 12. The porous film 12 is constituted of many fine pores 10 and oxide 13 of the anode-oxidizable layer surrounding the pores. The oxide layer at the bottom of pores 10 is called a barrier layer 14. The pores in the porous film are formed usually at random positions on the workpiece surface. However, when fine dents are formed on the workpiece surface as the anodization initiation points by electron ray lithography, nano-imprinting, FIB (focused ion beam), or a like method, the pores are formed only from the initiation points. Thereby, a porous film is prepared in which the pores are regularly formed in accordance with the arrangement pattern of the dents. In the anodization, the voltage V (volt) of anodization is selected preferably: regular arrangement pitch (nm)=2.5×V for obtaining a porous film having highly regular arrangement of pores.

The anode-oxidizable film is generally formed from Al for preparing the above porous film. Although a porous film can be formed from a material like Si or Ti other than Al, the material other than Al has disadvantages such that the formed pores are not precisely perpendicular, and use of hydrofluoric acid is necessary as the aqueous acidic solution for the anodization. The inventors of the present invention have found that the porous film having perpendicular pores can be formed, similarly as from Al, from an Al alloy mainly composed of Al and containing at least one element selected from the group of Nb, Ta, Ti, Hf, Zr, Mo, and W. Alloying of Al enables decrease of roughness on the film surface caused by hillock or grain interface. Therefore the alloying of Al is especially effective for forming fine dents as the anodization initiation points on the workpiece surface. The amount of the alloying element added to the Al ranges preferably from about 5 atom % to 50 atom % depending on the added element for formation of perpendicular pores similarly as in Al.

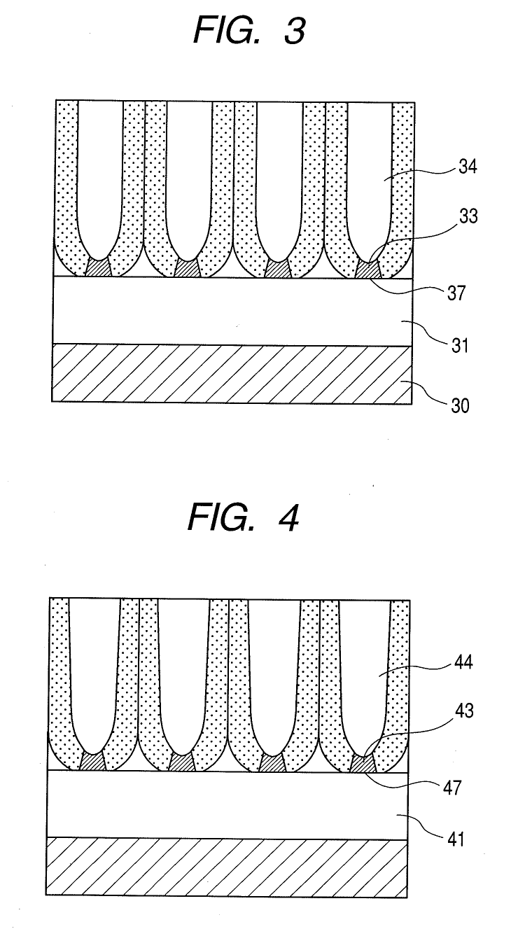

By further anodization, porous film 22 grows from the workpiece surface toward the substrate to have the bottom of barrier layer 20 to reach underlying metal layer 21 as illustrated in FIG. 2. Underlying metal layer 21 is formed from a material containing at least one element selected from the group of Nb, Ta, Ti, Hf, Zr, Mo, and W. With this constitution, the inventors of the present invention have found that oxide 33 containing an element of underlying metal layer 31 grows from underlying metal layer 31 into pore 34 in bottom 37 of the porous film as illustrated in FIG. 3.

The diameter of the pores can be enlarged (pore-widening) by immersion in a phosphorus acid solution or the like.

The inventors of the present invention found that, in the pore-widening, the anode-oxidizable film formed from the Al alloy for the porous film has the etching resistance depending on the kind and amount of the alloying material. Therefore, the horizontal cross-sectional diameter of the pores can be varied in the perpendicular direction by forming the Al alloy film by varying the amount of the added alloying material in the perpendicular direction. For example, with a more etching-resistant element like Zr or Hf to the Al alloy, the sectional diameter of pore 44 can be enlarged from the substrate side toward the bared surface by decreasing the amount of the added element from the substrate side toward the surface side, as illustrated in FIG. 4. Similarly when different kinds of elements are employed in the Al alloy film formation, the horizontal cross-sectional diameter can be increased from the substrate side toward the surface side by laminating the Al alloy containing a more etching resistant element in the substrate side and the Al alloy containing less etching-resistant element in the surface side. Therefore, the diameter of the pores can be controlled as desired by selecting the Al alloy material and the pore-widening conditions.

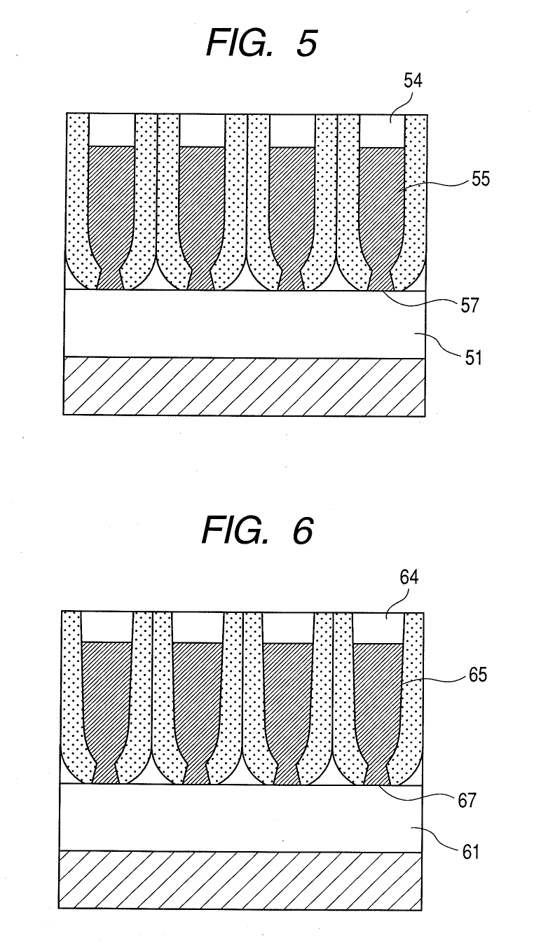

Further anodization of the workpiece in the state of FIG. 3 in an electrolytic solution for obtaining a barrier type anodization film like a solution of ammonium borate, ammonium tartarate, or ammonium citrate can grow columnar members 55 composed of the oxide of the underlying metal layer to fill pores 54 as illustrated in FIG. 5. This columnar member reflects the shape of the pores in the porous film. Therefore the cross-sectional diameter of the columnar member can be increased toward the bared surface (FIG. 6). As described above, the shape of the pores in the porous film affects decisively the control of the shape of the columnar member constituted of the oxide.

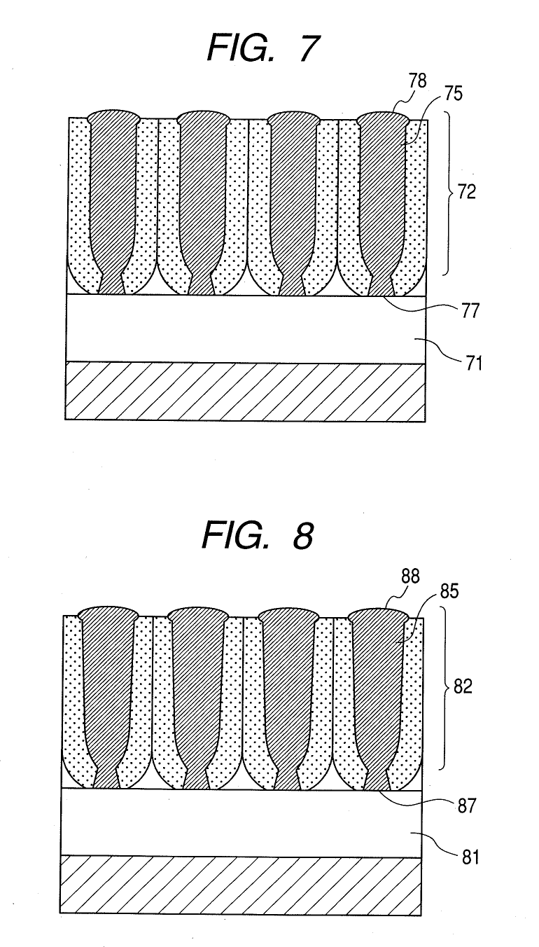

The height of the columnar member formed in the pore depends on the anodization voltage, and the respective columnar members grow nearly in a uniform height with the top end kept flat. By the anodization at a voltage higher than that necessary for the columnar member top to reach the porous film surface, the growth can occur not only in the perpendicular direction but also in the horizontal direction. Thereby outside the bared face, the top end portion of the columnar member has curve-faced top portion 78, as illustrated in FIG. 7. Here the columnar member portion grown in the pore and curve-faced top portion are combinedly called a projecting structural member. The member grown in the pore having a diameter varying with the height of the pore (FIG. 8) is called the same. By anodization at a still higher voltage, the intervals between the tops of the projecting structural members come to decrease to results in contact between all of the projecting structural members.

For more precise control of the shape of the top end portion, the anodization process may be conducted as follows. As illustrated in FIG. 5, columnar member composed of the oxide of the barrier type anodized film are formed in the pores. Then a part of the columnar structure portion constituted of the porous film and the oxide is polished. The polishing can be conducted with a slurry. Colloidal silica which is weakly alkaline and stable is suitable for the flatness owing to its CMP (chemical mechanical polish) including mechanical polishing and chemical etching. After the polishing and washing, the anodization is conducted again in an electrolytic solution like an aqueous ammonium borate solution for obtaining a barrier type of anodized film. Thereby a structure can be obtained which has a shape illustrated in FIGS. 7 and 8 and a uniform height of the columnar structure parts and a uniform shape of the curved face of the column top ends.

Next, a process is described for providing projections constituted of the projecting structural members through a step of removal of porous film prepared by the anodization.

The workpiece containing the oxide of the underlying metal grown as illustrated in FIGS. 7 and 8 is subjected to wet etching in an acid or alkaline solution. In this etching, the anode-oxidizable layer mainly composed of Al is removed selectively by dissolution by utilizing the difference in etching resistance between the anode-oxidizable layer and the oxide of the underlying metal to leave the projecting structural members as the projections. The alumina formed by anodization is classified crystallographically as γ-Al₂O₃. While α-Al₂O₃ has high crystallinity, γ-Al₂O₃ has low crystallinity. With decrease of the crystallinity, the resistance to etching by an acid or alkali becomes weaker. Therefore γ-Al₂O₃ is etched readily by a weak acid like phosphoric acid. The projecting structural part is prepared from the underlying metal as a barrier type of anode-oxidized film. The resistance to etching thereof to the acid or alkali depends on the kind of the element of the underlying metal layer, and the possible valence of the element in the oxide. For example, Ta oxide is insoluble in an acid and is resistant also to alkali etching. Of Nb oxides, NbO containing bi-valent Nb is soluble in an acid or an alkali, whereas NbO₂ and Nb₂O₅ of a higher oxidation number of 4 or 5 are insoluble in an acid and have improved resistance to alkali etching.

The projections can be formed by selecting the kind, concentration, and time of the etching in consideration of the resistance to the etching of the oxide.

On the other hand, reportedly in the case where the projecting structural part constituted of a barrier type anode-oxidizable film can contain oxides of plural valence number, the valence of the oxide can vary between at the surface and at the interior, having a higher valence in the periphery portion and a lower oxidation number in the interior. Further, incorporation of an oxide from the electrolytic solution of the anode oxidation, crystal defect, and inclusion of the combined water affect greatly the resistance of the oxide to the etching, and finally affect the strength of the produced columnar projections.

After the formation of the projecting structural parts, the workpiece is heat-treated in an oxidative atmosphere to remove the impurities such as combined water and to form an oxide of a higher oxidation number for higher resistance to the etching. The heat treatment under the oxidative atmosphere improves the strength of the projecting structural parts suitable for use as a magnetic recording medium utilizing the projection structure.

Regarding the temperature of the heat treatment, the higher the temperature, the more improved is the resistance to the etching of the oxide, whereas the crystallinity of the alumina of the porous film to be removed comes to be increased gradually by the heat-treatment at the higher temperature from γ-Al₂O₃ to become less soluble in an acid or alkali. In some cases where a vertical recoding medium is formed with a soft-magnetic layer provided between the underlying metal layer and the substrate, the deterioration of the properties by heating of the soft-magnetic layer should be taken into consideration. From the above considerations, the heat-treatment temperature ranges from 200° C. to 400° C., preferably from 250° C. to 350° C. At the temperature lower than 200° C., the effect of the heat treatment is not achieved sufficiently, whereas at the temperature higher than 400° C. the soft-magnetic property can deteriorate.

The heat treatment may be conducted either after preparation of the projecting structural part or after the etching of the anode-oxidizable layer composed of the alumina alloy. The conditions of the alumina etching should be selected depending on when the etching is conducted.

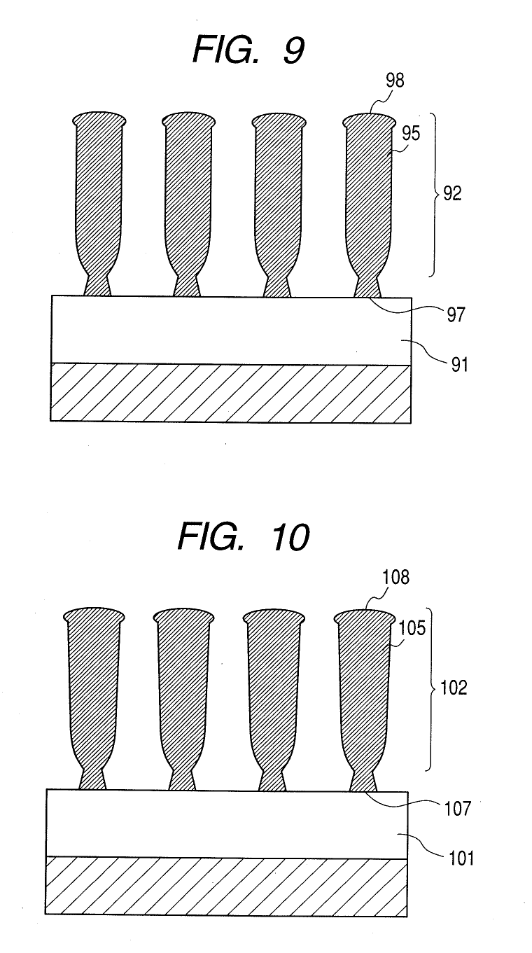

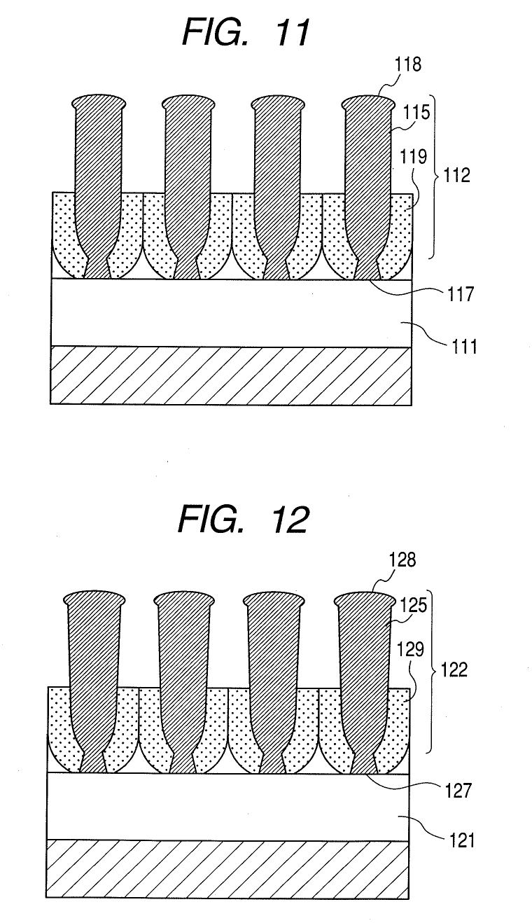

Complete removal of the porous film gives projecting structural part 92 constituted of an oxide of the underlying metal layer 91, as illustrated in FIG. 9. A part of the porous film may be kept unetched, if necessary, as illustrated in FIG. 11. Similarly, the projecting structural part (FIG. 8) formed from a porous film having diameters of pores varying with the depth of the pore can be etched: complete etching of the porous film gives a structure illustrated in FIG. 10; partial etching thereof gives a structure illustrated in FIG. 12. In either case, the structure has a reverse taper-shaped columns as illustrated in FIGS. 10 and 12.

As described above, the projecting structural part is produced preferably through anodization and growth of the oxide of the underlying metal from under the anode-oxidizable film. Instead, other processes are possible as below.

In a process, the porous film can be prepared by forming pores on a resist by EB drawing or nano-printing, and later an underlying layer metal under the resist is allowed to grow in a projection shape by second anodization to form a projecting structural part.

In another process, on a film or a substrate like Si having a flat surface, a projecting structural members are formed which have flat top ends, and subsequently the top faces are rounded by CPM. The CPM rounds the corners of the top flat ends of the projecting structural members by mechanical polishing and chemical etching. The polishing should be conducted with a light load not to cause collapse of the projections.

Next, a process is described for forming a magnetic film as a recording layer on the top ends of the respective projecting structural members with reference to FIGS. 9 and 10. A similar result can be achieved with the structural part having the porous film left partly (FIGS. 11 and 12).

The film of the magnetic material as the recording layer is formed on curve-faced top ends of the columnar members. In this magnetic film formation, preferably the film-forming conditions are selected not to cause filling of the intercolumnar space. For example, in film formation by sputtering, the particle introduction direction, the deposition speed, the sputtering gas pressure, the gas flow rate, sputtering time, sputtering temperature, deposition film thickness are controlled.

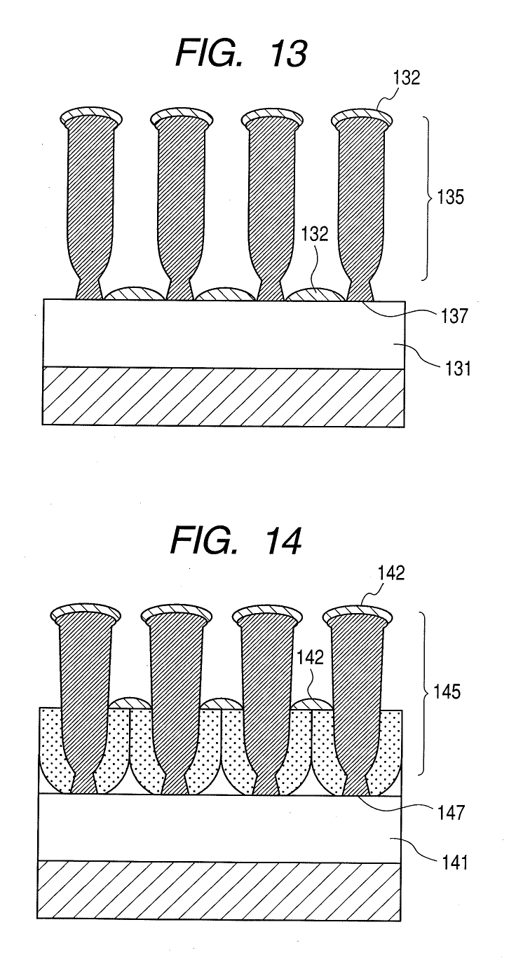

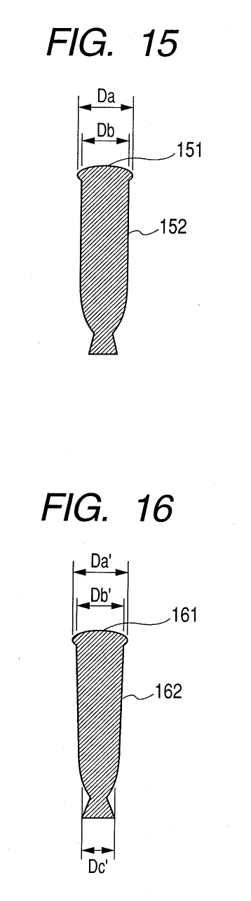

The magnetic material can deposit also on the bottom of the intercolumnar space as illustrated in FIGS. 13 and 14. The amount of deposition on the side walls of the columnar projections can be reduced by improving the directivity of the fly-incoming particles, although not completely. For separation of the magnetic material between the projection top ends, the deposition on the side wall is preferably decreased to be minimum. In the reverse-tapered columnar structure as illustrated in FIG. 14, the deposit on the side walls can be decreased further. In columnar structural portion illustrated in FIG. 15 (or 16), the maximum diameter Da (or Da′) of the horizontal cross-section of curve-faced portions 151 are larger than diameter Db (or Db′) of the horizontal cross-section of columnar member 152. With such a structure, the fly-incoming particles are intercepted not to cause deposition of the particles directly below the column top ends and to ensure complete segmentation of the magnetic material. With the above-mentioned structure, a patterned medium can be prepared which has the magnetic material on the column top ends for magnetic recording.

The magnetic material should be selected which has magnetic anisotropy reflecting the surface shape of the columnar projection: the anisotropy directing perpendicular to the tangent line of the curved face. The thickness of the magnetic material on the top ends of the columnar projections is limited for securing the magnetic separation of the magnetic material between the columnar projections. Further, since the resistance to the thermal fluctuation depends on the product of the magnetic anisotropic energy density and the volume, the magnetic material of a higher density of the magnetic anisotropic energy is preferably selected for the higher recording density. Under such conditions, preferred materials include multilayer film of [Co/M] (M=Pt, Pd); Co and CoPt having an hcp structure (hexagonal close-packed structure) having the c-axis orienting perpendicularly; and M′Pt or M′Pd (M′═Co, Fe) of L₁₀ regular structure having the c-axis orienting perpendicularly.

For improvement of the crystal orientation, an intermediate layer may be placed for orientation control between the top end portion of the columnar projection and the magnetic material, as necessary.

Such a magnetic material has the magnetic anisotropy dispersing relative to the substrate. Owing to the point-symmetrical structure of the top end portions (circular in the horizontal cross-section), the magnetic anisotropy is dispersed uniformly. That is, the magnetic anisotropy is partly inclined relative to the external magnetic field perpendicular to the substrate, which improves the sensitivity to the external magnetic field. Further, the dispersion of the respective magnetic material members is uniform, which uniformizes the sensitivity to the external magnetic field.

The magnetic material can be formed into a magnetic layer having a curved surface by depositing the magnetic material following the shape of the column top end. Thereby the formed magnetic layer has magnetic anisotropy oriented to be oblique relative to the substrate. This enables decrease of the reversing magnetic field of the magnetic layer against an external magnetic field perpendicular to the substrate. Thus the sensitivity to a leakage magnetic field of a recording head can be increased by the decrease of the reversing magnetic field with the thermal stability kept unchanged.

The curve-faced magnetic layer at the top end has preferably a curvature radius of not more than 5R (where R denotes the radius of the pore formed by anodization at the surface side), more preferably not more than 2R. With the curvature radius larger than 5R, the magnetic anisotropy of the magnetic layer deposited following the top end shape is directed nearly vertical to lose the effect of decreasing the reversing magnetic field.

The top end portion may have a partly flat face portion. The ratio of the curvature to the radius r of the flat face portion, R/r, is preferably not less than 1.5, more preferably not less than 2. At the ratio of R/r of less than 1.5, the magnetic anisotropy of the magnetic layer is directed nearly vertical to lessen the effect of decreasing the reversing magnetic field.

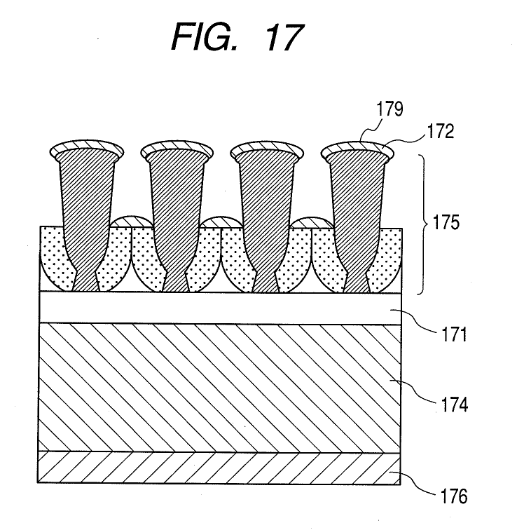

The structure of the present invention is useful as a magnetic recording medium. FIG. 17 illustrates schematically an embodiment of the recording medium. The recording medium is constituted mainly of substrate 176, underlying layer 174 such as a soft-magnetic layer formed on the substrate 176, underlying metal layer 171, projecting structural part 175, and magnetic layer 172. Underlying layer 174 like a soft-magnetic layer may include a particle size-control layer or a diffusion-controlling layer in addition to the backing soft-magnetic layer. In FIG. 17, the columns of the projecting structural part is reversely tapered, but is not limited thereto. The material surrounding walls of the columnar members of the projecting structural part may be completely removed as illustrated in FIG. 17.

For securing the hardness of the magnetic recording medium, a NiP layer may be formed by plating or a like method as a backing layer. The backing layer may be a film mainly composed of NiₜFe₁₋ₜ1 (t ranging preferably from 0.65 to 0.91). The backing layer may contain further Ag, Pd, Ir, Rh, Cu, Cr, P, B, or the like. Amorphous soft-magnetic material like FeTaC or CoZrNb is also useful as the backing layer.

The magnetic recording layer may contain an intermediate layer formed from the above-mentioned component for controlling the crystal orientation to improve the crystal orientation of the magnetic recording layer. The magnetic recording medium of the present invention may contain protecting layer or lubricating layer 179 for giving abrasion resistance. The material effective for the protection layer includes non-magnetic high-hardness material such as mond-like carbon carbide, and nitrides for abrasion resistance against friction with the head. The lubricating layer is preferably formed by application of PFPE (perfluoropolyether).

The magnetic recording medium of the present invention is useful as a perpendicular magnetic recording medium. A patterned medium having thermal fluctuation resistance and high recording sensitivity suitable for the present invention can be produced by the aforementioned process by forming regularly arranged pores by the anodization.

In the magnetic recording medium, the intercolumnar space may be filled again with a nonmagnetic material. After the refilling, the surface is preferably treated for flattening by CMP or milling. The refilled material may be an insulating material such as Al₂O₃ and SiO₂, a metal, or an organic compound. After the surface flattening, a protection layer or a lubricating layer may be formed as necessary.

### EXAMPLES

Examples of the present invention are described below.

### Example 1

A Ti film of 5-nm thick, a Nb film of 20-nm thick as an underlying metal layer, and an AlHf layer of 35-nm thick containing Hf at a content of 7 atom % are formed, on a Si substrate successively by sputtering. On the AlHf surface, small dents are formed in a square array at dent intervals of 25 nm as the anodization initiation points by an FIB process. The surface AlHf layer is anodized in an aqueous 1.0-mol/L sulfuric acid solution at a bath temperature of 3° C. at an anodization voltage of 10 V. The resulting porous film layer is wet-etched for pore-widening in an aqueous 5-wt % phosphoric acid solution at a bath temperature of 20° C. The pore diameter is found to be 12 nm by observation of the surface of the workpiece by FE-SEM.

The workpiece is further anodized in an aqueous 0.15-mol/L ammonium borate solution at a bath temperature of 22° C. at an anodization voltage of 19 V. Thereby, an oxide of the underlying Nb grows and expands into the pores to fill the pores as the projecting structural member 72 composed of Nb oxide as illustrated in FIG. 7. The bare surface of the porous film is found to have projections having respectively a curved top face by observation by scanning electron microscopy (SEM).

The workpiece is heat-treated in an atmospheric environment at 300° C. Then the porous film portion is removed in an aqueous 5-wt % phosphoric acid solution at 25° C. to obtain columnar Nb oxide members (A1) having curve-faced top ends as illustrated in FIG. 9. Columnar member 152 has a horizontal cross-sectional diameter Db of 12 nm, and the curve-faced portion 151 of the columnar member has a horizontal cross-sectional maximum diameter Da of 15 nm as illustrated in FIG. 15. When a fraction of the porous film material is left unetched by controlling the time of the immersion in the aqueous phosphoric solution, the columnar Nb-oxide members (A2) are obtained.

### Example 2

A Ti film of 5-nm thick, a Ta film of 20-nm thick as an underlying metal layer, and an AlHf layer of 35-nm thick containing Hf at a content of 7 atom % are formed, on a Si substrate successively by sputtering. On the AlHf surface, small dents are formed in a square array at dent intervals of 25 nm as the anodization initiation points by an FIB process. The surface AlHf layer is anodized in an aqueous 1.0-mol/L sulfuric acid solution at a bath temperature of 3° C. at an anodization voltage of 10 V. The resulting porous film layer is wet-etched for pore-widening in an aqueous 5-wt % phosphoric acid solution at a bath temperature of 20° C. The pore diameter is found to be 12 nm by observation of the surface of the workpiece by FE-SEM.

The workpiece is further anodized in an aqueous 0.15-mol/L ammonium borate solution at a bath temperature of 22° C. at an anodization voltage of 19 V. Thereby, an oxide of the underlying Ta grows and expands into the pores to fill the pores with the columnar members 72 composed of Ta oxide as illustrated in FIG. 7. The bare surface of the porous film is found to have projections having respectively a curve-faced top end by scanning electron microscopy (SEM).

The workpiece is heat-treated in an atmospheric environment at 300° C. Then the porous film portion is removed in an aqueous 5-wt % phosphoric acid solution at 25° C. to obtain a columnar Ta oxide member (B1) having curve-faced top ends as illustrated in FIG. 9. Columnar member 152 has a horizontal cross-sectional diameter Db of 12 nm, and the curve-faced portion 151 of the columnar member has a horizontal cross-sectional maximum diameter Da of 15 nm as illustrated in FIG. 15. When a fraction of the porous film material is left unetched by controlling the time of the immersion in the aqueous phosphoric solution, the columnar Ta-oxide members (B2) are obtained.

As described above, the underlying metal layer is constituted of at least one of the group of the metal elements of Nb, Ta, Ti, Hf, Zr, Mo, and W. However, the metallic Zr, when used singly as the underlying layer metal, diffuses readily into anode-oxidized alumina, the anodization product, and is liable to adversely affect the formation of the porous film. Therefore, the Zr is preferably used as an alloy. On the other hand, when the metallic W is used singly as the underlying layer metal, the heat treatment should be conducted under a reductive atmospheric environment for etching the W as the columnar metal member owing to the low etching resistance of the W columnar member.

### Example 3

A Ti film of 5-nm thick, a Nb film of 20-nm thick as an underlying metal layer, and an AlHf layer of 35-nm thick are formed, on a Si substrate successively by sputtering. In this Example, in formation of the AlHf film, the ratio of Hf to Al is varied from 12 atom % to 5 atom % based on Al from the substrate side toward the surface side. On the AlHf surface, small dents are formed in a square array at dent intervals of 25 nm as the anodization initiation points by an FIB process. The surface AlHf layer is anodized in an aqueous 1.0-mol/L sulfuric acid solution at a bath temperature of 3° C. at an anodization voltage of 10 V. The resulting porous film layer is wet-etched for pore-widening in an aqueous 5 wt % phosphoric acid solution at a bath temperature of 20° C. The pore diameter is found to be increased from the substrate side toward the surface side by observation by FE-SEM as illustrated in FIG. 4.

The workpiece is further anodized in an aqueous 0.15-mol/L ammonium borate solution at a bath temperature of 22° C. at an anodization voltage of 19 V. Thereby, an oxide of Nb of the underlying layer grows and expands into the pores to fill the pores to form the columnar members 85 composed of Nb oxide as illustrated in FIG. 8. The bare surface of the porous film is found to have projections having respectively a curve-faced top ends outside by scanning electron microscopy (SEM).

Then the workpiece is heat-treated in an atmospheric environment at 300° C. Then the porous film portion is removed in an aqueous 5 wt % phosphoric acid solution at 25° C. to obtain a columnar Nb oxide member (C1) having curve-faced top ends as illustrated in FIG. 10. As illustrated in FIG. 16, columnar member 162 has curve-faced portion 161 having a horizontal cross-sectional maximum diameter Da′ of 16 nm, horizontal cross-sectional column diameter Db′ of 14 nm, the minimum diameter at the substrate side Dc′ of 10 nm. When a fraction of the porous film material is left unetched by controlling the time of the immersion in the aqueous phosphoric solution, the columnar Nb-oxide members (C2) are obtained.

### Example 4

A Ti film of 5-nm thick, a Nb film of 20-nm thick as an underlying metal layer, and an AlHf layer of 50-nm thick containing Hf at 7 atom % are formed, on a Si substrate, successively by sputtering. On the surface of this workpiece, aluminum alkoxide is applied in a thickness of 20 nm by spin coating. The workpiece is baked at 90° C. for 20 minutes. On the surface of the alkoxide, dents as anodization initiation points are transferred from a mold by nano-imprinting. In this Example, a mold having projections of 15-nm high of triangle lattice array at 50-nm intervals is pressed against the alkoxide surface to transfer the projection array as the dent array for anodization initiation points.

By the above nano-imprinting, the projections of the mold is found to be transferred on the alkoxide surface as dents of about 5-nm deep by scanning plural sites of the alkoxide surface by AFM (atomic force microscope). Further, the workpiece is treated at 180° C. for ashing with ultraviolet ray and ozone for 10 minutes. Thereby the polymer portion in the alkoxide is removed and simultaneously the aluminum portion in the alkoxide is oxidized.

Then, the workpiece is subjected to anodization in an aqueous 0.3-mol/L sulfuric acid solution at 16° C. at a voltage of 20 V. The above alkoxide layer and aluminum layer are simultaneously anodized. After the anodization, the surface of the workpiece is observed by SEM (field emission scanning electron microscopy). Thereby, a porous film is confirmed to have dents in a triangle lattice array corresponding to the projection array on the mold. The porous film is wet-etched for pore-widening by immersion in an aqueous 5-wt % phosphoric acid solution at 20° C. to widen the pore diameter to 27 nm.

The workpiece is further anodized in an aqueous 0.15-mol/L ammonium borate solution at a bath temperature of 22° C. at an anodization voltage of 30 V. Thereby, the Nb of the underlying layer grows as an oxide and expands into pores 54 to fill the pores to form columnar member 55 composed of Nb oxide as illustrated in FIG. 5. With the above voltage, the oxide of Nb does not grow to the level of the bare surface of the anodized porous film.

The porous film and the filled columnar member are partly polished with colloidal silica to flatten the surface. The amount of the polishing can be controlled by the polishing time. In this Example, the height of the polished face from the bottom of the underlying metal layer is 50 nm. After this surface flattening, the workpiece is subjected to anodization in an aqueous 0.15-mol/L ammonium borate at the bath temperature of 22° C. The applied voltage is gradually raised. The anodization is conducted at a voltage higher by 2 V than the voltage at which the current begins to flow. The Nb oxide grows in accordance with the voltage to form projections having curve-faced portion 78 as illustrated in FIG. 7. The current flow initiation voltage depends on the amount of the polishing. For example, when the polishing is not conducted, the Nb oxide does not grow at a voltage lower than 25 V for anodization.

Then the workpiece is heat-treated in an atmospheric environment at 300° C. Then the porous film portion is removed in an aqueous 5-wt % phosphoric acid solution at 25° C. to obtain a columnar Nb oxide member (D) having curve-faced top ends as illustrated in FIG. 9. As illustrated in FIG. 15, columnar member 152 has a horizontal cross-sectional column diameter Db of 27 nm, and curve-faced portion 151 thereof has a horizontal cross-sectional maximum diameter Da of 30 nm. According to SEM observation, columnar Nb oxide member D1 produced through the method of Example 4 is excellent in uniformity: the projecting structural part has top ends uniform in the shape and height of the projection.

### Comparative Example 1

A porous film is formed by anodization in the same manner as in Example 4. The diameter of the pore is adjusted to 30 nm by pore-widening treatment. Anodization is conducted in an aqueous ammonium borate solution to fill the pores with Nb oxide as columnar members in the same manner as in Example 4. This workpiece is polished with colloidal silica to remove partly the porous film and Nb oxide for flattening to make the height to be equal to the Nb oxide columnar member D in Example 4.

Subsequently, the workpiece is heat treated at 300° C. in the atmospheric environment, and the porous film is removed in an aqueous phosphoric acid solution, in the same manner as in Example 4 to obtain a comparative sample (E1) of the columnar Nb oxide member. According to SEM observation, the columnar member has a cross-sectional diameter of 30 nm, and flat top ends.

### Example 5

A film of a magnetic material is formed on the top ends of the respective columnar oxide members A1, A2, B1, B2, C1, C2, D1, and E1. The films are formed by sputtering in the order of Ti of 1-nm thick, Pt of 3-nm thick, and CO₃Pt of 7-nm thick successively. The sputtering is conducted with the target of 5 cm diameter placed at a distance of 15 cm from the workpiece in a argon gas atmosphere of 0.1 Pa by applying a DC electric power of 50 W. According to detailed examination of the structures by TEM (transmission electron microscopy), on the columnar oxide members A1, A2, B1, B2, C1, C2 and D1, films are formed by following the curved surface shape of the top ends to give film-coated columnar oxide structure A1′, A2′, B1′, B2′, C1′, C2′, and D1′. In the trench portions other than the top ends, films are formed in nearly the same thickness: Ti of 1-nm thick, Pt of 3-nm thick, and Co₃Pt of 7-nm thick. On the side walls of the columnar oxide members, some deposit is formed but is isolated completely from the deposit on the top end portions. In comparison of the columnar oxide structures A1‘ and C1’, deposition on the side wall is less in the columnar oxide structure C1′. The columnar oxide structures A1′, A2′, B1′, B2′, C1′, C2′, and D1′ has the desired construction.

On the other hand, in the columnar oxide structure E1′ which is prepared by film formation on the columnar oxide structure E1, the flat portion of the top end is not completely isolated from the deposit on the side wall even though the deposition on the side wall is less. However, the side wall portion is not formed in a film state but is formed in a particle state, so that the two parts are roughly isolated magnetically.

### Example 6

On the resulting columnar oxide structure A1, a magnetic material film is formed in a film to place the magnetic material on the top end portions. In the film formation, firstly a MgO film is formed by sputtering with the target kept at distance of 15 cm from the workpiece in an argon gas of 0.1 Pa by RF power of 50 W in a film thickness of 5 nm on the top of the projections. Subsequently, a magnetic material film is formed with a FePt target at a substrate temperature of 350° C. to form a FePt film of 7 nm thick containing Fe at a content of 50 atom %. Then the film is annealed at 400° C. in a hydrogen atmosphere. The resulting columnar oxide structure A1″ has the intended construction regardless of the kind of the magnetic material.

### Example 7

As illustrated in FIG. 17, on a glass substrate, a CoZrNb layer as a backing soft-magnetic layer is formed in a thickness of 150 nm, and thereon a films of Ti of 5-nm thick, Nb of 20-nm thick, and AlHf (Hf: 7 atom %) of 50-nm thick are formed successively. Then in the same process as in Example 4 and Comparative Example 1, columnar Nb-oxide structures D1 and E1 are prepared. On the above structures, films of Ti of 1-nm thick, Pt of 3-nm thick, and CO₃Pt of 7-nm thick are formed to prepare columnar Nb oxide structures D1′ and E1′ in the same process as in Example 5. Further thereon, a diamond carbon layer is formed as a protection layer, and PFPE layer is formed as a lubricating layer to obtain a magnetic recording medium D and a magnetic recording medium E.

The recording state is evaluated, after AC demagnetization, by contact recording with a magnetic recording head by increasing the writing current, namely increasing the head recording magnetic field. The magnetic field of the head at saturation of the reproduction signal is observed for the recording mediums D and E. The writing current at the saturation of the signal intensity is: (recording medium D)<(recording medium E). Thus the recording medium D has found to have higher sensitivity to the head magnetic field.

The above result is not limited to the magnetic recording medium D produced from the columnar Nb oxide structure D1, but is applicable to all of the test mediums of the present invention. For example, the columnar Nb oxide structures A1, A2, B1, B2, and C1 give respectively a medium having a high sensitivity similarly as the magnetic recording medium D for the head recording magnetic field.

As shown by the above Examples, a patterned medium having thermal fluctuation-resistance and high recording sensitivity can be produced by placing a magnetic material on the rounded top ends of the projections.

The structure of the present invention is useful for a magnetic recording medium owing to the thermal fluctuation resistance and high recording sensitivity.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-202366, filed Aug. 2, 2007, which is hereby incorporated by reference herein in its entirety.

What is claimed is:

1. A structure having projecting structural members perpendicular to a substrate, the projecting structural members having respectively a curved top-end face covered continuously with a magnetic material.

2. The structure according to claim 1, wherein the projecting structural members are respectively constituted of a top-end portion and a columnar structural portion, and the top end portion has a horizontal cross-sectional maximum diameter larger than a diameter of the columnar structural portion.

3. The structure according to claim 1, wherein the columnar structural portion has a horizontal cross-sectional diameter larger at the surface side than at the substrate side.

4. The structure according to claim 1, wherein the magnetic material has magnetic anisotropy oriented to be normal to the curved top-end face.

5. The structure according to claim 1, wherein the projecting structural member is constituted of at least one oxide of the elements selected from Nb, Ta, Ti, Hf, Zr, Mo, and W.

6. The structure according to claim 1, wherein the projecting structural members are uniform in shape, and are arrayed at uniform intervals.

7. A magnetic recording medium, comprising the structure set forth in claim 1.

8. A process for producing a structure, comprising the steps of:
placing an underlying metal layer and an anode-oxidizable layer successively on a substrate;
anodizing the anode-oxidizable layer to form a porous film having pores perpendicular to the substrate;
growing an oxide of a metal element of the underlying metal layer from the bottoms of the pores of the porous film to form columnar structural members in the pores;
polishing partly the porous film and the columnar structural members;
forming a projecting structural members, each being constituted of the columnar structural member and a curve-faced top end portion;
removing a part or the entire of the porous film; and
placing a magnetic material on the top end portions of the projecting structural members.

9. A process for producing a structure, comprising the steps of:
placing an underlying metal layer and an anode-oxidization layer successively on a substrate;
anodizing the anode-oxidization layer to form a porous film having pores perpendicular to the substrate;
growing an oxide of a metal of the underlying metal layer from the bottoms of the pores of the porous film to outside of the porous film to form projecting structural members through the pores, each constituted of a columnar structural portion and a curve-faced top-end portion;
removing a part or the entire of the porous film; and
placing a magnetic material on the top-end portions of the projecting structural members.

10. The process for producing a structure according to claim 9, wherein the underlying metal layer is constituted of at least one oxide of the elements selected from Nb, Ta, Ti, Hf, Zr, Mo, and W.

11. The process for producing a structure according to claim 9, wherein the projecting structural members are formed by second anodization.

12. The process for producing a structure according to claim 11, wherein the second anodization is conducted in an electrolytic solution selected from of an aqueous ammonium borate solution, an aqueous ammonium tartarate solution, and an aqueous ammonium citrate solution.

13. The process for producing a structure according to claim 9, wherein the step of removing a part or the entire of the porous film is conducted by wet-etching.

14. The process for producing a structure according to claim 9, wherein the projecting structural members are heat-treated in an oxidative atmosphere.

15. The process for producing a structure according to claim 9, wherein the step of placing the magnetic material is conducted by deposition of a fly-incoming particles for film formation having directivity toward the substrate.

16. The process for producing a structure according to claim 9, wherein the process includes placing an intermediate layer is placed between the projecting structural member and the magnetic material.
